(19) United States
(12) Patent Application Publication
(10) Pub. No.: US 2015/0168707 A1
(43) Pub. Date: Jun. 18, 2015

(54) SURGICAL MICROSCOPE AND A RETROFITTING SET FOR A SURGICAL MICROSCOPE

(71) Applicant: Carl Zeiss Meditec AG, Jena (DE)

(72) Inventors: Joern Dechow, Crailsheim (DE); Alexander Schenk, Frankehardt (DE)

(21) Appl. No.: 14/570,119

(22) Filed: Dec. 15, 2014

(30) Foreign Application Priority Data
Dec. 17, 2013 (DE) 10 2013 226 288.4

(51) Int. Cl. G02B 21/36; G02B 21/00

(52) U.S. Cl. CPC G02B 21/368; G02B 21/0012

(57) ABSTRACT

A surgical microscope (1) for magnified observation of an operation field at a patient (4) comprises, for keeping the patient (4) better informed or entertained, an additional display device (2) for displaying information or media to the patient (4). Furthermore, an appropriately embodied retrofitting set for a surgical microscope is specified.

### CROSS REFERENCE TO RELATED APPLICATION

This application claims priority of German patent application no. 10 2013 226 288.4, filed Dec. 17, 2013, the entire content of which is incorporated herein by reference.

### FIELD OF THE INVENTION

The invention relates to a surgical microscope for magnified observation of an operation field at a patient and a retrofitting set for a surgical microscope.

### BACKGROUND OF THE INVENTION

Surgical microscopes are used in various fields of medicine for treating a patient by surgery and/or therapy. Such surgical microscopes find use, in particular, in ophthalmology and dentistry. By way of example, such a surgical microscope is distributed under the name OPMI ProErgo by the applicant.

A surgical microscope has at least one, preferably two binocular observation beam paths in order to enable the surgeon to see an operation field at a patient to be treated in a magnified manner by means of eyepieces, objectives, magnifying lenses and, optionally, further optical components. Hence, the surgeon or a treating medical practitioner can carry out a desired treatment, wherein a more precise treatment is made possible by the magnified display of the operation field. By way of example, surgical microscopes are used for replacing a cornea of the patient with an artificial cornea for the purposes of treating a cataract. Surgical instruments are likewise used for carrying out an operation in the oral cavity of the patient.

Furthermore, surgical microscopes may include further technical functionalities in order, for example, to record microscopic images with the aid of confocal laser endoscopy or to record an image during the treatment in accordance with the principles of optical coherence tomography. Furthermore, the surgical microscope can be configured in such a way that a partial light beam is decoupled from one or more observation beam paths via beam splitters and fed to an image acquisition device in order to detect an image of the operation field externally in real-time, for example for teaching purposes. Moreover, the surgical microscope may also include one or more observation beam paths for an assistant or a second surgeon.

Finally, the surgical microscope may also include one or more illumination devices in order to illuminate the operation field in a desired manner such that, for example, no regions in the operation field are in the shadow.

Such a surgical microscope is illustrated in an exemplary manner in EP 1 997 423 A1, which can be traced back to the applicant.

Particularly in the case of lengthy dental treatments it is known that the patient, who is lying passively on a treatment chair, requires distraction. To this end, use can be made of headphones in order to play, inter alia, the patient's favorite music to them. Furthermore, it is known for a ceiling monitor to be attached above the treatment chair in order, for example, to show a feature film to the patient. However, in the process, the direct view of the ceiling monitor is often at least partly covered by the surgical microscope situated above the face, in particular above the oral region. It is also known for the patient to put on a so-called optical head-mounted display, via which, for example, a feature film is likewise shown to the patient. However, it should be considered disadvantageous here that the optical head-mounted display makes monitoring of the patient by the treating medical practitioner more difficult as the medical practitioner can no longer directly see the eyes of the patient and consequently cannot register the onset of nausea in the patient.

### SUMMARY OF THE INVENTION

It is an object of the invention to provide a surgical microscope that can display arbitrary data or information to the patient without visual impairment, wherein continuous monitoring of the patient must be ensured.

According to the invention, this object is achieved by a surgical microscope for magnified viewing of an operation field at a patient including an ancillary display device configured to display information to the patient.

A basic concept of the invention is to equip a surgical microscope known per se, as is, for example, distributed by the applicant as mentioned above, with an additional display device in order to depict information or data to the patient. This means that the display device is not spatially and/or physically separated from the surgical microscope, as in the case of, for example, a ceiling monitor or an optical head-mounted display, but rather it is a constituent of the surgical microscope or of the whole surgical microscope system. Here, the surgical microscope system comprises the actual surgical microscope for magnified imaging of the operation field and all ancillary instruments which were mentioned above in an exemplary manner, as well as holders or stands or the like, which are described below. Here, the display device is arranged and aligned on the surgical microscope in such a way that, during normal use of the surgical microscope, that is, if, for example, a dental treatment is being carried out, the display device is arranged and aligned relative to the surgical microscope in such a way that it is visible in a direct and unimpeded manner to the patient who is sitting or lying underneath the surgical microscope so that the patient can perceive the information displayed thereon.

Within the scope of the invention, the term display device should be understood to mean a device for displaying information or data, for example a monitor, a display or a screen, in particular a flat-panel display or a display as used in modern mobile communication apparatuses for enabling a color and high-resolution display. Furthermore, the data or information in fact displayed within the scope of the invention are arbitrarily selectable; by way of example, it is possible to depict live moving images or freeze frames of the operation field or, for example, a film which entertains the patient. It is understood that, to this end, the display device is linked via data lines known per se to a data source, for example the aforementioned image acquisition device of the surgical instrument or any other data medium, such as a hard disk drive recorder, a video recorder or a DVD player. By way of example, it is also possible for the patient himself to navigate through various video offerings using a suitable menu, for example via a remote control, or to select a television channel desired by him.

Furthermore, it is clear that provision is preferably made for a synchronized audio playback device, for example headphones, so as also to be able to hear the sound of the film. Naturally, the audio playback and/or the image playback on the display device can be interrupted by the treating medical practitioner in order to allow the medical practitioner to discuss various aspects of the treatment currently being carried out. This is brought about in a manner of a “pause” function, which is triggered by the medical practitioner via an appropriately embodied actuation device, for example on his foot pedal for controlling the surgical microscope.

The surgical microscope is preferably equipped with an image acquisition unit, wherein a partial beam path can be decoupled from an observation beam path and, for example, fed to a video camera. The image of the operation field acquired thus can be recorded, displayed on an external monitor and/or shown on the display device for the patient. Consequently, the patient can directly follow the treatment. It is also possible that, under control of the treating medical practitioner, a freeze frame or a snapshot of the operation field is shown so as to be able to explain an aspect of the treatment to the patient. Furthermore, it is also possible to import recordings which were previously stored in a storage medium of the surgical microscope, for example from the time of the surgery preparations, in order, as it were, to enable a before/after comparison.

In a simple manner, the display device, for example, a color display is integrated into a housing of the surgical microscope and consequently forms part of the housing itself. It is understood that, in the process, the display device is tilted or aligned substantially horizontally in such a way that the played-back information can be seen directly and without visual impairment by the patient. An advantage of this embodiment is that the whole surface of the surgical microscope and of the display, which is, for example, inserted flush into the housing, can be cleaned and/or sterilized in a simple manner.

In an alternative embodiment, the display device is attached to the surgical microscope or thereto at the housing thereof, in particular attached in a manner movable relative to the surgical microscope. As a result of the arrangement or the alignment of the display device being modifiable relative to the objective, the display of the information or data to the patient can always be ensured, even in the case of different arrangements or alignments, which may also change during the treatment. By way of example, the display device can be attached to the surgical microscope in a manner pivotable or swivellable about one or more spatial axes or the distance between surgical microscope and display device can be modified as desired by means of, for example, a telescopic element. Hence, a treating medical practitioner can, where necessary, modify the arrangement or alignment of the surgical microscope relative to the patient during the treatment as desired and, subsequently, for example, an assistant can modify the arrangement or alignment of the display device in such a way that it is once again visible to the patient.

In principle, arbitrary technical solutions may be selected for the movable attachment of the display device, for example on the housing of the surgical instrument. Proposed here in particular are goosenecks, as are known from, for example, bedside table lamps. At one end, the gooseneck is attached to the surgical microscope or the housing thereof and the display device is arranged at the other end of the gooseneck. The gooseneck can then be kinked, curved or bent as desired in order to align the display device relative to the patient in a manner ideal for the latter. Furthermore, the display device can be arranged on the surgical microscope via a lockable ball head or a supporting ring holder is provided at the housing of the surgical microscope in order to be able to rotate the display device, as it were, around the surgical microscope into the desired position via a rotatable supporting ring or rotary swivel. Here too, provision can be made for locking at the desired position and the display device is then attached to the supporting ring, for example via the aforementioned ball head. It is understood that data transmission to the display device is ensured via, for example, appropriately embodied wiring. However, in principle, the display device can also be operated with rechargeable batteries and it receives the displayed information or data wirelessly, for example, via a Bluetooth interface.

In order to be able to reliably clean and/or disinfect the surgical microscope and the additional display device, the display device can also be configured to be removable, for example by means of a plug-in connection between the surgical microscope and gooseneck. Removability also offers the advantage that, if it hinders the treating medical practitioner in performing the treatment, it can briefly be removed in order to allow a treatment to be carried out in the best possible manner.

In order to be able to align the surgical microscope with the additional display device along the three spatial axes relative to the operation field as desired and, possibly, in order to be able to swivel or pivot these about one or more rotational axes, the surgical microscope, for example, the aforementioned OPMI ProErgo, can be mounted on a stand or stand base which in turn is displaceable. In an alternative embodiment, the surgical microscope with the additional display device can for example be suspended from a ceiling or wall of the treatment room, for example via a shear mechanism, wherein, to this end, provision is made in particular of additional rotary and/or swivel joints in order to align the surgical microscope or the shear mechanism relative to the operation field as desired.

In a further alternative embodiment, the display device is not arranged or attached directly on the surgical microscope or the housing thereof, but rather on the aforementioned stand or stand base or on a ceiling or wall mount of the surgical microscope. It lends itself particularly in this embodiment to attach the display device to the aforementioned components by means of a gooseneck or any other, in particular telescopable, attachment device, with it being necessary to ensure that the display device itself does not protrude into the actual operation field.

If the display apparatus is attached to the surgical microscope in a manner rotatable or swivellable thereto, an advantageous embodiment includes the display device being able to be swivelled or pivoted in such a way that the information or data played back thereon, in particular a live image of the operation field, can be displayed by an assistant, a second treating medical practitioner or any other interested observers. By way of example, an assistant can pivot the display device into his field of view during the operation in such a way that he can follow the treatment via the display device in the same manner as the treating medical practitioner sees the operating field through the surgical microscope. Likewise, the surgeon himself or the treating medical practitioner can pivot the display device toward him in order, for example, to describe the treatment.

Here, in principle, it would also be possible for the display device to be embodied in such a way that, for example, the patient is shown a feature film or any other entertainment program by means of a first display facing downward and, on the rear side, as it were on the top side of the display device, provision is made for a further display or the like, via which, for example, an assistant can see the operation field.

Particularly when the display device is attached to the surgical microscope in a manner pivotable and/or swivellable with respect thereto, the effect that may occur is that the displayed information, that is, for example, a feature film, is displayed to the patient with a rotated alignment. By way of example, this occurs if the treatment requires the surgical microscope overall to be swivelled by 90° about a perpendicular axis. For this purpose, it is proposed that the orientation or alignment of the displayed data is correspondingly swivellable. By way of example, this is known from the screens or displays of modern mobile communication apparatuses, the image display of which changes accordingly if the apparatus is tilted by, for example, 90°.

Furthermore, it is proposed that the display device is embodied as a retrofitting set for an already available surgical microscope. To this end, the display device, that is, for example, a color display, is equipped with attachment means in order to attach it to the surgical microscope, the housing thereof, to a stand or to a wall or ceiling mount. By way of example, the display device can be equipped with a type of clamp in order to securely clip it, latch it or securely fasten it in any other way to the housing of the surgical microscope. What lends itself here is an autonomous power supply of the display device using rechargeable batteries and a wireless data transmission to the display device.

### BRIEF DESCRIPTION OF THE DRAWING

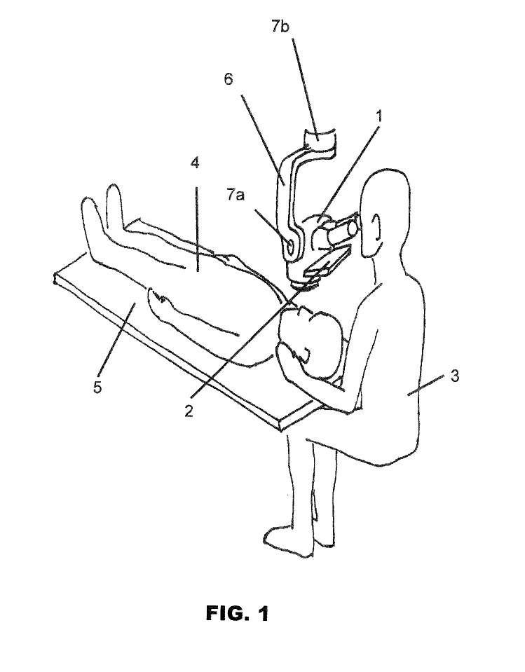

The invention will now be described with reference to the single FIGURE of the drawing (FIG. 1) which shows a patient being treated by a medical practitioner with a surgical microscope according to the invention.

### DESCRIPTION OF THE PREFERRED EMBODIMENTS OF THE INVENTION

The schematic illustration of FIG. 1 depicts how a patient 4 to be treated lies on a couch 5. In principle, the patient 4 can also sit or lie in the treatment chair of a dentist or an oral and maxillofacial surgeon. The treating medical practitioner 3 or a surgeon or any other user in this case sits at the head end of the couch 5, for example in order to be able to carry out a dental treatment. To this end, he peers through a surgical microscope 1, which is depicted schematically here with a housing and two eyepieces for a binocular observation beam path. The surgical microscope 1 is arranged above the face or the oral region of the patient 4 via a ceiling holder 6. What can be seen from the schematic illustration is that the ceiling holder 6 is embodied in such a way that the surgical microscope 1 is, for example, pivotable at rotary joints (7a, 7b) about one or more axes of rotation such that the surgical microscope 1 can be aligned in relation to an operation field in a desired manner and the operation field can be observed in a magnified manner by the medical practitioner 3.

Furthermore, the surgical microscope 1 is equipped with a display device 2. Here, the display device 2 can be either integrated into the housing of the surgical microscope 1 or, as depicted schematically in FIG. 1, attached to the outside of the housing of the surgical microscope 1. Here, the display device 2 is arranged on the surgical microscope 1 in such a way that the actual function of the surgical microscope 1, namely the magnified display of the operation field, that is, for example, of the oral region of the patient 4, is not adversely affected. The display device 2 can be embodied in the form of a display or a flat-panel screen which, in particular, is attached to the surgical microscope 1 in a manner pivotable and/or swivellable in relation to the latter. Therefore, the display device 2, for example a color display as is known from modern mobile communication apparatuses, can in each case be aligned ideally in respect of the field of view of the patient 4. Via the display device 2, it is possible to depict in principle arbitrary data and/or information, for example a freeze-frame or a live recording from the operation field. However, in particular, it is also possible that, for example, a feature film is shown to the patient 4 for distraction purposes. In this case, the display device 2 is preferably synchronized with an audio playback device, for example headphones, such that the patient can also hear the corresponding sound.

It is understood that the display device 2 includes a power supply with rechargeable batteries or a cable, and also a data reception device in order to receive in principle arbitrary information or data via a cable or wirelessly, for example via a Bluetooth interface. In particular, the display device 2 can also be releasably attached to the surgical microscope 1 if a treatment situation requires this.

The display device 2 can likewise be embodied as a retrofitting set with appropriately embodied attachment means in order to attach it to an already available surgical microscope.

It is understood that the foregoing description is that of the preferred embodiments of the invention and that various changes and modifications may be made thereto without departing from the spirit and scope of the invention as defined in the appended claims.

### LIST OF REFERENCE SIGNS

1 Surgical microscope

2 Display device

3 Medical practitioner

4 Patient

5 Couch

6 Ceiling holder

7a,b Rotary joint

What is claimed is:

1. A surgical microscope for magnified viewing of an operation field at a patient comprising:
an ancillary display device configured to display information to the patient.

2. The surgical microscope of claim 1 further comprising:
an image acquisition unit configured to acquire images of the operation field; and,
said ancillary display device is configured to display said acquired images of the operation field to the patient.

3. The surgical microscope of claim 1, wherein the surgical microscope includes a housing; and, said ancillary display device is integrated in said housing.

4. The surgical microscope of claim 1, wherein said ancillary display device is attached to said surgical microscope in such a manner so as to be movable relative to said surgical microscope.

5. The surgical microscope of claim 1 further comprising:
at least one of a gooseneck, a ball head and a supporting ring holder; and,
said ancillary display device being attached to the surgical microscope via said at least one of a gooseneck, a ball head and a supporting ring holder.

6. The surgical microscope of claim 1, wherein said ancillary display device is configured to be removable.

7. The surgical microscope of claim 1 further comprising: one of a stand, a wall mount and a ceiling mount; and, the surgical microscope is arranged on said one of a stand, a wall mount and a ceiling mount.

8. The surgical microscope of claim 7, wherein said ancillary display device is configured to be attached to said one of a stand, a wall mount and a ceiling mount.

9. The surgical microscope of claim 1, wherein said ancillary display device is pivotable so as to be viewable by at least one of an assistant, an aid and a surgeon.

10. The surgical microscope of claim 1, wherein said ancillary display device is configured to display at least one of data and information in an orientation; and, said orientation is adjustable.

11. The surgical microscope of claim 1, wherein said ancillary display device is configured to display entertainment media to the patient.

12. A retrofitting set for a surgical microscope comprising:
a display device;
an attachment device configured to attach said display device to the surgical microscope.
